(19) United States
(12) Patent Application Publication
(10) Pub. No.: US 2025/0378185 A1
(43) Pub. Date: Dec. 11, 2025

(54) SYSTEM FOR SUPPORTING SETTING OF AUTHORITIES TO BE GRANTED TO ROLES IN WORKFLOW

(71) Applicant: Hitachi, Ltd., Tokyo (JP)

(72) Inventors: Kentaro IMAI, Tokyo (JP); Shinsuke HAMADA, Tokyo (JP); Michio IIJIMA, Tokyo (JP); Naoki INOUE, Tokyo (JP)

(21) Appl. No.: 19/066,240

(22) Filed: Feb. 28, 2025

(30) Foreign Application Priority Data
Jun. 6, 2024 (JP) 2024-092351

(51) Int. Cl. G06F 21/60

(52) U.S. Cl. CPC G06F 21/604; G06F 2221/2145

(57) ABSTRACT

A system stores task information for managing a position of each of task in the workflow, relationship management information for managing a relationship among nodes, authority types and the tasks, and conversion information for managing a relationship between the authority types and a display method for each node. The system, in a display of a first workflow, determines a position of the each of the nodes by referring to the relationship management information and the task information, determines a display method for the each of the nodes by referring to the relationship management information and the conversion information, displays the each of the nodes at the determined position corresponding to one of the tasks based on the determined display method representing the authority type, and changes a display method for a first node in response to a user operation of changing the authority type of the first node.

### CLAIM OF PRIORITY

The present application claims priority from Japanese patent application JP 2024-092351 filed on Jun. 6, 2024, the content of which is hereby incorporated by reference into this application.

### BACKGROUND

There is a known a technology for supporting tasks of a customer by registering and running an on-site workflow of the customer in a system. For example, a system engineer talks with the customer about such tasks, and registers a workflow tailored to the customer in the system. The system engineer grants an authority to each role for each task.

For example, in JP 2019-160135 A, it is disclosed that “a process planning module changes a process plan relating to assembly of a product, and a display control module displays a map in which each work step is plotted on a coordinate system in which the order of the work steps after the change is shown on a first axis (horizontal axis) and the order of the work steps before the change is shown on a second axis (vertical axis), and displays adjacent thereto a map in which each work step is plotted on a coordinate system in which the order of the work steps after the change is shown on the first axis (horizontal axis) and a structure-based order in a product structure work step table is shown on the second axis (vertical axis)” (described in, for example, Abstract).

A workflow may display a large number of tasks, for example, over 100 tasks. A system engineer is required to grant authorities for all the over 100 tasks to each role. Therefore, a technology that can appropriately support the setting of authorities in a workflow is desired. In JP 2019-160135 A, it is not possible to support the setting of authorities in roles.

### SUMMARY

An aspect of this invention is a system for supporting setting of authorities to be granted to roles in a workflow, the system including a storage device, and a processor. The storage device stores task information for managing a position corresponding to each of tasks in the workflow, relationship management information for managing a relationship among nodes, authority types, and the tasks, and conversion information for managing a relationship between the authority types and a display method for each of the nodes. The processor is, in a display of a first workflow, configured to determine a position of the each of the nodes by referring to the relationship management information and the task information, determine a display method for the each of the nodes by referring to the relationship management information and the conversion information, display the each of the nodes at the determined position corresponding to one of the tasks based on the determined display method representing the authority type, and change a display method for a first node in response to a user operation of changing the authority type of the first node.

Further features relating to this invention will become apparent from the descriptions in this specification and the accompanying drawings. Aspects of this invention may also be achieved and implemented by means of the elements of this invention, combinations of various elements of those elements, and modes described in the following detailed description and the appended claims.

It should be understood that the descriptions in this specification are merely representative examples, and should not be construed as limiting the scope of claims or application examples of this invention in any way.

According to the at least one aspect of this invention, the setting of authorities in a workflow can be appropriately supported.

### BRIEF DESCRIPTION OF THE DRAWINGS

FIG. 1 shows an example of a graphical user interface (GUI) for setting authorities in a workflow in a first embodiment of this specification.

FIG. 2 shows an example of an operation on the individual workflow by a user for setting authorities.

FIG. 3 shows a configuration example of an authority setting support system for supporting processing of granting authorities to roles in a workflow.

FIG. 4 is a diagram for illustrating a hardware configuration example of the authority setting support device in the embodiments of this specification.

FIG. 5 shows a configuration example of the role table.

FIG. 6 shows a configuration example of the activity table.

FIG. 7 shows a configuration example of the authority table.

FIG. 8 shows a configuration example of the node table.

FIG. 9 shows a configuration example of the relationship management table.

FIG. 10 shows a configuration example of the edge table.

FIG. 11 shows a configuration example of the authority vertical position conversion table.

FIG. 12 is a diagram for illustrating an outline of the GUI processing of an individual workflow by the authority setting support device.

FIG. 13 is a flowchart for illustrating an example of processing executed by the individual visualization processing module.

FIG. 14 is a flowchart for illustrating a processing example by the individual screen display module.

FIG. 15 is a flowchart for illustrating a processing example by the screen operation module.

FIG. 16 shows an example of node images displayed on the individual workflow screen.

FIG. 17 shows a configuration example of an authority pattern conversion table.

FIG. 18 shows a configuration example of an authority radius conversion table.

FIG. 19 shows an example of an overall workflow in the second embodiment of this specification.

FIG. 20 is a flowchart for illustrating an example of overall processing by the authority setting support device, including display of the overall workflow and the individual workflow.

FIG. 21 is a diagram for illustrating a logical configuration and a processing outline of the authority setting support device which displays the overall workflow and the individual workflow.

FIG. 22 shows a configuration example of the role vertical position conversion table.

FIG. 23 is a flowchart for illustrating an example of processing executed by the overall visualization processing module.

FIG. 24 is a flowchart for illustrating a processing example by the overall screen display module.

FIG. 25 shows an image example of the individual workflow displayed on the user terminal of the person setting the authorities (editor).

FIG. 26 shows an example of an individual workflow which is a GUI image displayed on the user terminal of the administrator.

FIG. 27 shows an example of an individual workflow which includes a search window.

FIG. 28 shows that the node is shown as having also been simultaneously moved to the authority type “view” in response to the node being moved by the pointer from the authority type “-” to the authority type “view”.

### DETAILED DESCRIPTION OF THE EMBODIMENTS

Now, referring to the accompanying drawings, description is given of embodiments of this specification. In the accompanying drawings, components that are functionally the same are sometimes denoted by the same reference symbols. It should be noted that the accompanying drawings are illustrations of specific embodiments and implementation examples in conformity with the principle of this invention, but those are used for the understanding of this invention and never used to limit the interpretation of this invention.

In the embodiments of this invention, the description thereof is given in detail enough for a person skilled in the art to carry out this invention, but it is necessary to understand that other implementations and modes are possible and that changes in configurations and structures and substitutions of diverse components can be made without departing from the scope and spirit of the technical idea of this invention. Therefore, the following description should not be interpreted as being limited thereto.

In addition, as described later, the embodiments of this specification may be implemented by software running on a general-purpose computer, by dedicated hardware, or by a combination of software and hardware.

When each processing step in the embodiments of this specification is described by using the “processing module as a program” as the subject of the sentence (the object that is performing the operation), the program is executed by a processor (for example, a central processing unit (CPU)) to perform designated processing while using a memory and a communication port (communication control device), and thus the term “processor” may serve as the subject of the sentence.

### First Embodiment

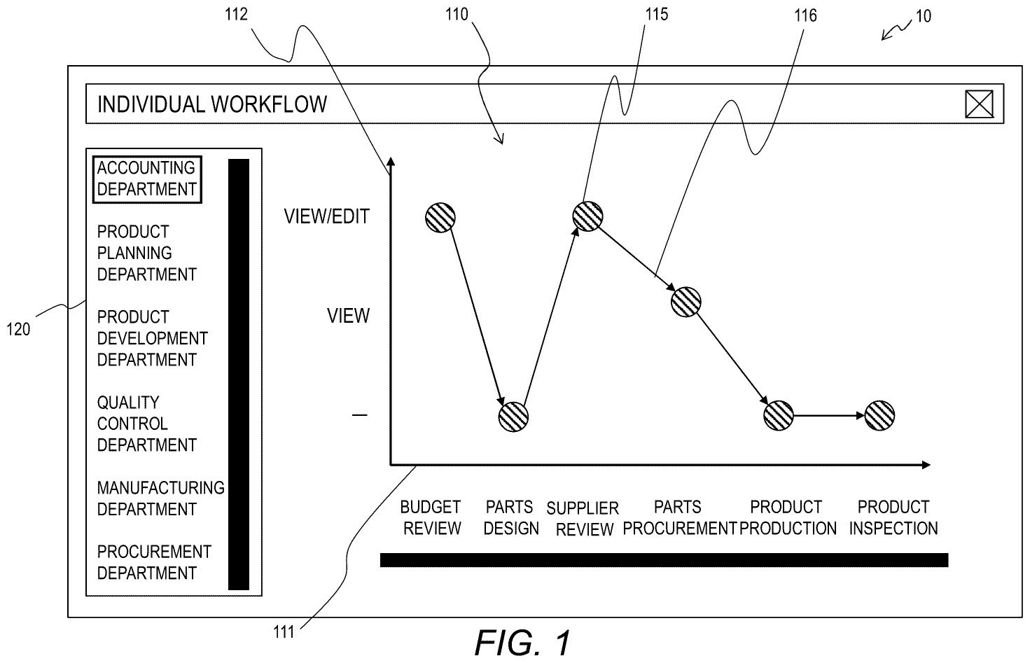

In FIG. 1, an example of a graphical user interface (GUI) for setting authorities in a workflow in a first embodiment of this specification is illustrated. The GUI displays an individual workflow 10 for specifying authorities for roles in the workflow. Description is now given of objects indicated in the individual workflow 10.

In the example illustrated in FIG. 1, a role list 120 shows the names of roles defined in a workflow. Specifically, an accounting department, a product planning department, a product development department, a quality control department, a manufacturing department, and a procurement department are defined. The role list 120 shows all the roles in the workflow and the role selected as a target for which authorities are to be set. In the example of FIG. 1, the accounting department is selected as the target for which authorities are to be set. In the role list 120, the target for which authorities are to be set may be selectable.

The individual workflow 10 displays a graph 110 for receiving designation of the authorities to be granted to the selected role. The graph 110 has a linear horizontal axis 111 indicating tasks (actions) to be sequentially performed in a workflow, and a linear vertical axis 112 indicating authorities to be set. In other words, different positions (coordinates) on the vertical axis indicate different authority types (types), and different positions (coordinates) on the horizontal axis indicate different tasks. In the example illustrated in FIG. 1, the graph 110 is defined by two axes that are perpendicular to each other, but in another embodiment, the angle between the axes may not be perpendicular, the axes may not be linear, or more than two axes may be defined.

In the example of FIG. 1, an access authority for task-related data is granted for each task. Three types of authorities are defined. Specifically, the three defined authority types are an authority type which allows viewing and editing (“view/edit”), an authority type which allows only viewing (“view”), and an authority type “-” (no authorities) which prohibits both editing and viewing.

An authority different from a data access authority may be settable. For example, the individual workflow 10 may display other authority information as an authority for metadata, such as an authority to display a node of the individual workflow 10 or an authority to operate a node, and receive setting of that authority. In addition, the types of the authorities to be granted and the number of authority types can change in accordance with a task flow.

In the graph 110, nodes 115 indicating the authority type for each task are shown as circles. The coordinates of a node indicate the task and the authority granted for the task. In FIG. 1, as an example, one node is denoted by reference numeral 115. For example, for “budget review,” the “view/edit” authority is granted to the accounting department, and for “parts design,” no authorities at all are granted to the accounting department (authority type “-”).

In the graph 110, edges 116 connecting nodes representing consecutive tasks in the workflow are displayed by arrows. In FIG. 1, one edge is denoted by reference numeral 116 as an example. The edges 116 can represent the execution order of the tasks in the workflow.

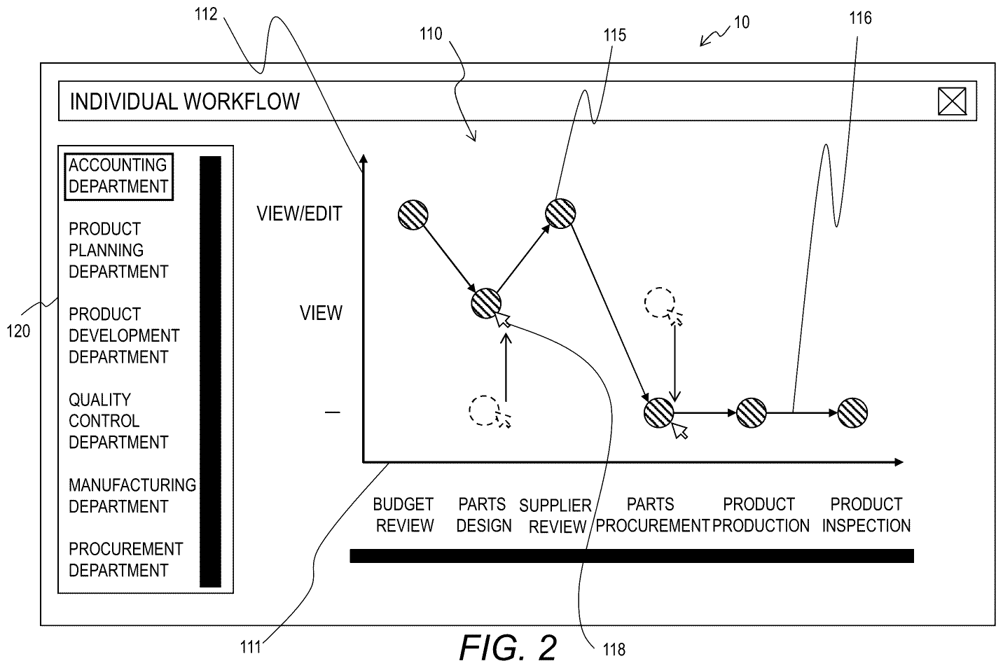

In FIG. 2, an example of an operation on the individual workflow 10 by a user for setting authorities is illustrated. The user can change the authority (authority type) granted to the role for each task by using a pointer 118 to select and move a node. In this example, the individual workflow 10 only allows nodes to be moved in the vertical axis direction. In the example illustrated in FIG. 2, a node 115A indicating the authority type for “parts design” is changed from no authorities “-” to the view authority “view,” and a node 115B indicating the authority type for “parts procurement” is changed from the view authority “view” to no authorities “-.”

As described above, the GUI displays the authorities granted to the roles in the workflow in a graph. As a result, the user can easily recognize the authority for each of a large number of tasks granted to a role. Further, by making it possible to change the authority granted for a task by moving an object, or by moving a node in the above-mentioned example, it becomes possible to easily designate the authority for each of a large number of tasks granted to a role.

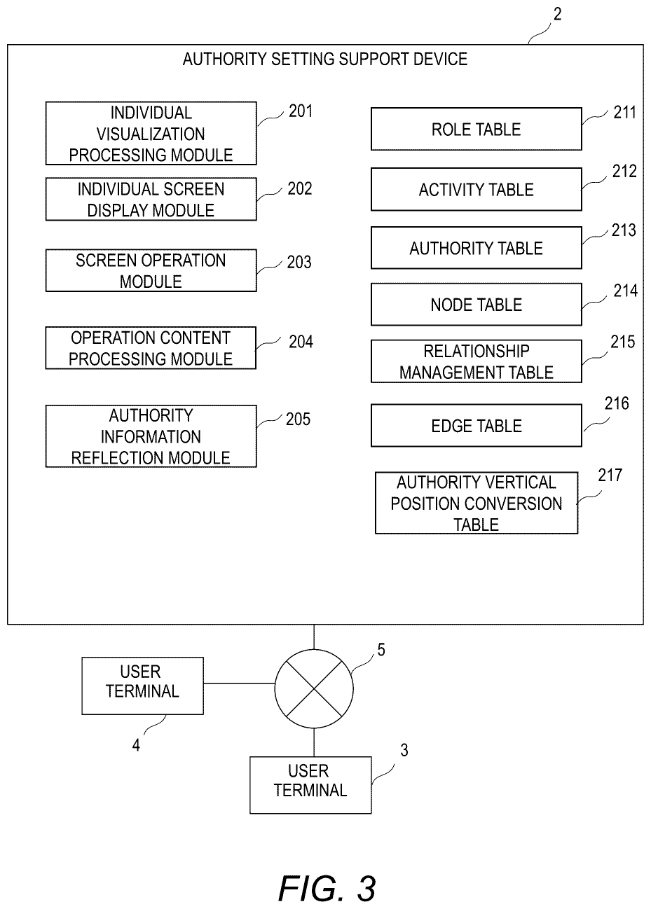

In FIG. 3, a configuration example of an authority setting support system for supporting processing of granting authorities to roles in a workflow is illustrated. The system illustrated in FIG. 3 is a computer system. The computer system includes an authority setting support device 2 and user terminals 3 and 4. The user terminals 3 and 4 and the authority setting support device 2 communicate via a network 5. The network 5 may include any one or more types of network.

The user terminal 3 is a computer including an input/output device used by a user (editor) who sets the authorities in the workflow, and functions as an interface device with respect to the authority setting support device 2. The user can access the authority setting support device 2 from the user terminal 3 and set the authority granted to each role in each task in the workflow. The user terminal 3 displays the GUI image described with reference to FIG. 1 and FIG. 2 received from the authority setting support device 2, and transmits inputs from the user to the authority setting support device 2.

The user terminal 4 is a user terminal used by another user, for example, a workflow administrator. The user terminals 3 and 4 execute an application, such as a web browser or a dedicated application, for communicating to and from the authority setting support device 2. The user terminals 3 and 4 may be omitted, and the input/output device of the authority setting support device 2 may be used.

The authority setting support device 2 provides a GUI for setting the authorities in the workflow to the user via the user terminal 3. The authority setting support device 2 can be built from one or a plurality of server devices, for example. The authority setting support device 2 includes an individual visualization processing module 201, an individual screen display module 202, a screen operation module 203, an operation content processing module 204, and an authority information reflection module 205. Further, the authority setting support device 2 stores a role table 211, an activity table 212, an authority table 213, a node table 214, a relationship management table 215, an edge table 216, and an authority vertical position conversion table 217.

The function modules 201 to 205 in the authority setting support device 2 may be implemented by a processor executing a program, or may be implemented by a hardware module installed in accordance with each function module.

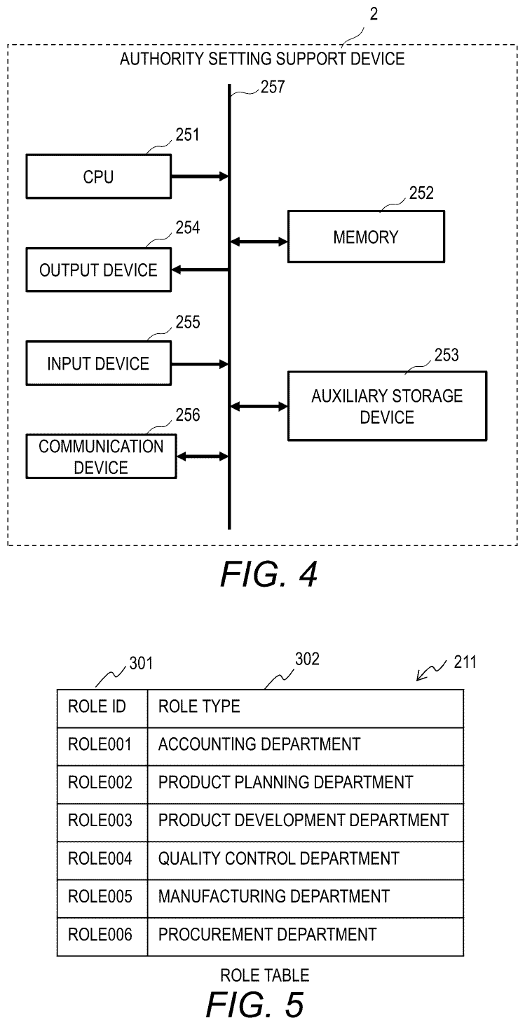

FIG. 4 is a diagram for illustrating a hardware configuration example of the authority setting support device 2 in the embodiments of this specification. Description is now given of the hardware configuration example of the authority setting support device 2, but the user terminal 3 may also have a similar configuration.

The authority setting support device 2 includes, for example, a CPU (processor) 251 which executes various programs, a memory (main storage device) 252 which stores various programs, and an auxiliary storage device 253 which stores various types of data. The CPU 251 can include one or a plurality of cores. The memory 252 is, for example, a dynamic random-access memory (DRAM) including a volatile storage area. The auxiliary storage device 253 is, for example, a hard disk drive (HDD) or a flash memory, and can provide a nonvolatile storage area.

The authority setting support device 2 further includes an output device 254 for presenting information to the user of the device, an input device 255 for receiving inputs of, for example, instructions and images from the user, and a communication device 256 for communicating to and from other devices. Those devices are coupled to each other by a bus 257.

The function modules of the authority setting support device 2 illustrated in FIG. 3 can be implemented, for example, by the CPU 251 operating in accordance with a program. The CPU 251 reads various programs from the memory 252 and executes the programs as required. The memory 252 can store programs corresponding to the respective function modules 201 to 205 illustrated in FIG. 3. Each program is loaded into the memory 252 from, for example, the auxiliary storage device 253, and executed by the CPU 251. At least some of the function modules may be configured from a logic circuit.

The auxiliary storage device 253 stores data which is referred to or managed by the various programs. For example, the auxiliary storage device 253 can store the tables 211 to 217 illustrated in FIG. 3.

The output device 254 is built from devices such as a display, a printer, and a speaker. The input device 255 is built from devices such as a keyboard, a mouse, and a microphone. The output device 254 presents results of inputs from the user and presents results of processing by the authority setting support device 2. Instructions from the user are input to the authority setting support device 2 through the input device 255. When the user terminal 3 is used, the input/output devices of the user terminal 3 can function in the same manner, and the output device 254 and the input device 255 can be omitted.

The communication device 256 receives, for example, data transmitted via the network including the user terminal 3 from another device coupled thereto, and transmits the results of processing by the authority setting support device 2 to the another device. Some of the devices may be omitted.

Description is now given of the various pieces of information stored in the authority setting support device 2. In FIG. 5, a configuration example of the role table 211 is shown. The role table 211 defines an ID and the type of each role in the workflow. The role table 211 has a role ID column 301 and a role type column 302. The role type column 302 indicates the name of the role type in the workflow.

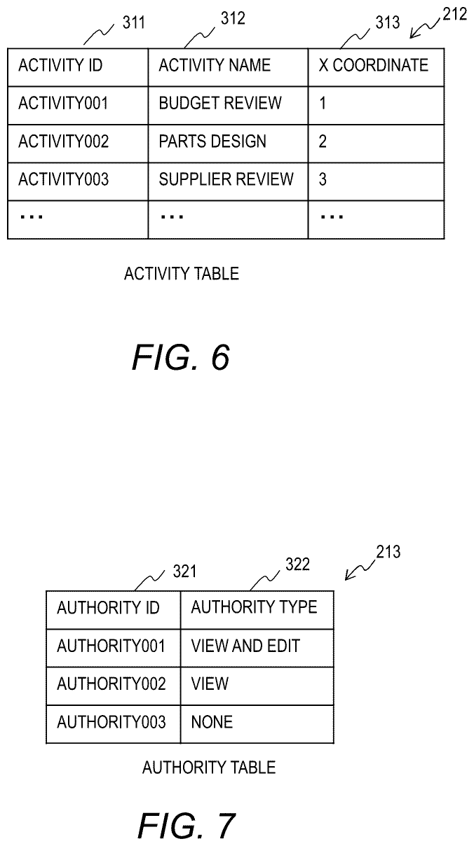

In FIG. 6, a configuration example of the activity table 212 is shown. The activity table 212 manages actions, or more specifically tasks, in the workflow. The activity table 212 has an activity ID column 311, an activity name column 312, and an X coordinate column 313.

The activity ID column 311 indicates the ID of each task in the workflow, and the activity name column 312 indicates the name of each of those tasks. The X coordinate column 313 indicates the coordinate on the horizontal axis (X axis) assigned to each task in the graph of the individual workflow 10 described with reference to FIG. 1 and FIG. 2.

In FIG. 7, a configuration example of the authority table 213 is shown. The authority table 213 has an authority ID column 321 and an authority type column 322. The authority ID column 321 indicates the ID of each authority in the workflow, and the authority type column 322 indicates the type of each authority. As shown in FIG. 7, not having an authority (“none”) is also included as an authority type. As described with reference to FIG. 1 and FIG. 2, the first embodiment defines authorities to access data, including an authority for viewing and editing, and an authority for viewing only.

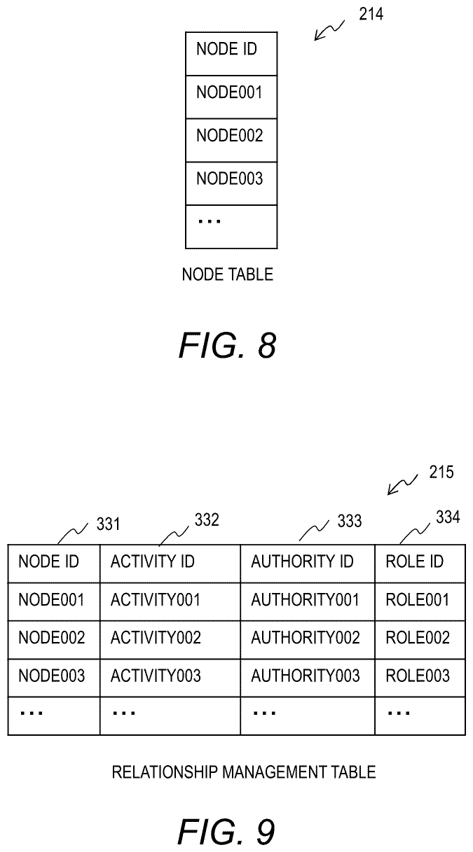

In FIG. 8, a configuration example of the node table 214 is shown. The node table 214 indicates the ID of each node displayed on the authority setting GUI.

In FIG. 9, a configuration example of the relationship management table 215 is shown. The relationship management table 215 indicates a relationship between each node and other information. Specifically, the relationship management table 215 has a node ID column 331, an activity ID column 332, an authority ID column 333, and a role ID column 334.

The node ID column 331 indicates the same node ID as in the node table 214. The activity ID column 332 indicates the ID of the task indicated by each node. The authority ID column 333 indicates the ID of the authority indicated by each node. The role ID column 334 indicates the ID of the role indicated by each node.

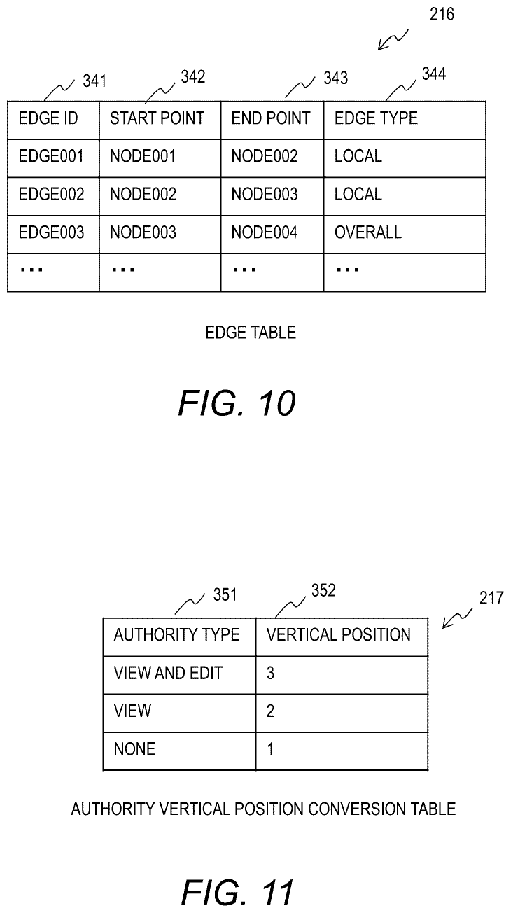

In FIG. 10, a configuration example of the edge table 216 is shown. The edge table 216 manages information on edges connecting adjacent nodes, which are displayed on the authority setting GUI. The edge table 216 has an edge ID column 341, a start point column 342, an end point column 343, and an edge type column 344.

The edge ID column 341 indicates the edge ID. The start point column 342 and the end point column 343 indicate the start point node and the end point node, respectively, of the edge. The edge type column 344 indicates the type of the GUI screen displaying the edges.

As described later, the authority setting support device 2 presents, in addition to the screen (individual workflow) showing the authority for each task granted to one role, as described with reference to FIG. 1 and FIG. 2, a screen (overall workflow) showing the authority for each task granted to each of a plurality of roles. In this example, the edge type of the individual flow is “local,” and the edge type of the overall workflow is “overall.” The node IDs shown in the node table 214 and the relationship management table 215 indicate the IDs of all the nodes on the two types of GUI screens. When an overall workflow is not prepared, the edge type column 344 is omitted.

In FIG. 11, a configuration example of the authority vertical position conversion table 217 is shown. The authority vertical position conversion table 217 indicates the position (coordinate) on the vertical axis (Y axis) of each authority type in the individual workflow 10. Specifically, the authority vertical position conversion table 217 has an authority type column 351 and a vertical position column 352. The authority type column 351 indicates the authority type to be placed in the workflow, and the vertical position column 352 indicates the position on the vertical axis (Y-axis coordinate) of the authority type in the graph of each individual workflow.

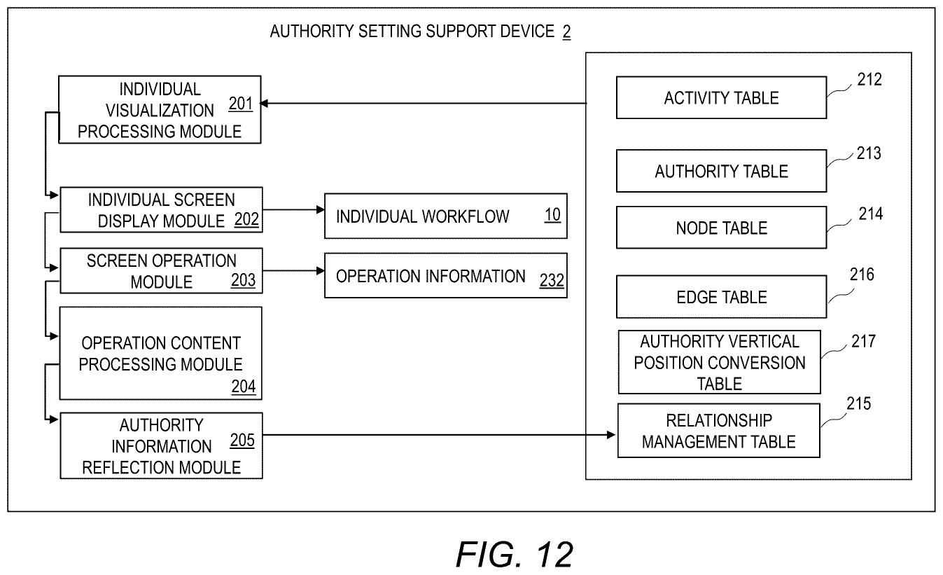

Next, description is given of the GUI processing of the individual workflow by the authority setting support device 2, that is, display of the individual workflow, and change in the management information and the display content in response to a user operation. FIG. 12 is a diagram for illustrating an outline of the GUI processing of an individual workflow by the authority setting support device 2.

The individual visualization processing module 201 acquires information for generating (an image of) the individual workflow 10 from the role table 211, the activity table 212, the authority table 213, the node table 214, the edge table 216, and the relationship management table 215.

Next, the individual visualization processing module 201 calls the individual screen display module 202, and the individual screen display module 202 generates and displays the individual workflow 10 from the information acquired by the individual visualization processing module 201.

Next, the individual screen display module 202 calls the screen operation module 203. The screen operation module 203 acquires the content of the operation (input) by the user for the individual workflow 10. Further, the screen operation module 203 calls the operation content processing module 204.

The operation content processing module 204 determines, from the operation content, the content of the change in the information on the individual workflow 10. In addition, the operation content processing module 204 calls the authority information reflection module 205. The authority information reflection module 205 updates the relationship management table 215 in accordance with the content of the change.

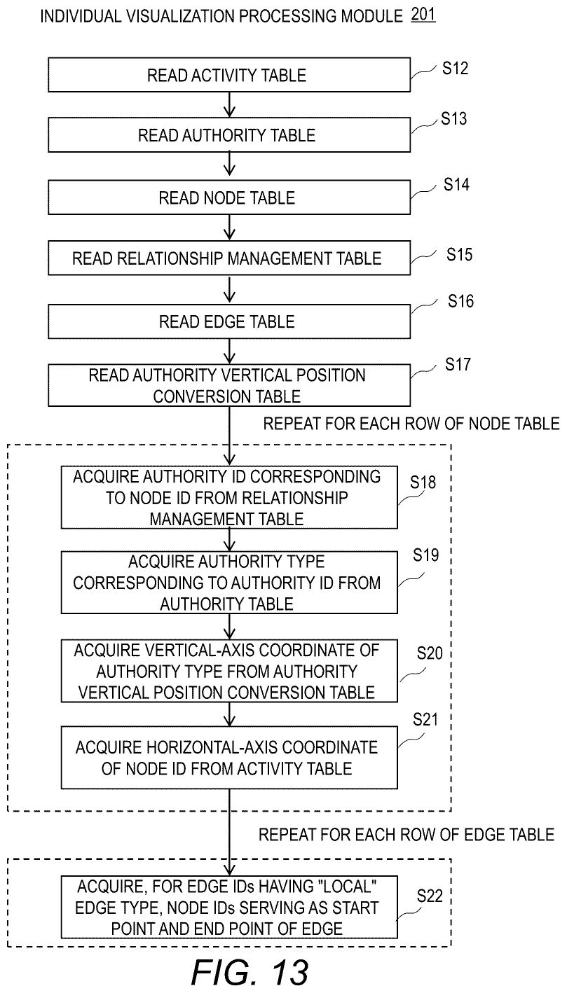

The processing by each function module is now described with reference to flowcharts. FIG. 13 is a flowchart for illustrating an example of processing executed by the individual visualization processing module 201. The individual visualization processing module 201 reads the information to be used in the processing. Specifically, the individual visualization processing module 201 reads the activity table 212, the authority table 213, the node table 214, the relationship management table 215, the edge table 216, and the authority vertical position conversion table 217 (S12 to S17).

Next, the individual visualization processing module 201 executes Step S18 to Step S21 for each node ID indicated by the node table 214. Specifically, the individual visualization processing module 201 acquires the authority ID corresponding to the node ID from the relationship management table 215 (S18). Next, the individual visualization processing module 201 acquires the authority type corresponding to the acquired authority ID from the authority table 213 (S19). Next, the individual visualization processing module 201 acquires the vertical-axis coordinate (vertical position) of the acquired authority type from the authority vertical position conversion table 217 (S20). Further, the individual visualization processing module 201 acquires the horizontal-axis coordinate (X coordinate) of the node ID from the activity table 212 (S21).

Next, the individual visualization processing module 201 executes Step S22 for each edge ID indicated by the edge table 216. Specifically, the individual visualization processing module 201 acquires, for the edge IDs having a “local” edge type, node IDs serving as the start point and end point of the edge (S22).

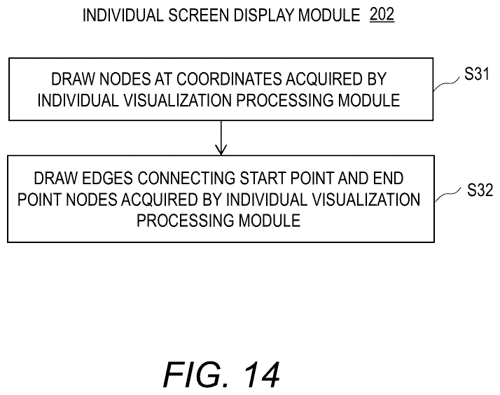

FIG. 14 is a flowchart for illustrating a processing example by the individual screen display module 202. The individual screen display module 202 draws the individual workflow 10. The individual screen display module 202 draws the nodes 115 in the graph 110 of the individual workflow 10 at the coordinates acquired by the individual visualization processing module 201 (S31). Further, the individual screen display module 202 draws, in the graph 110 of the individual workflow 10, the edges 116 connecting the start point and end point nodes acquired by the individual visualization processing module 201 (S32). The role list 120 in the individual workflow 10, and the role table 211 and the activity table 212, may be referred to in order to display non-variable information such as the tasks on the horizontal axis.

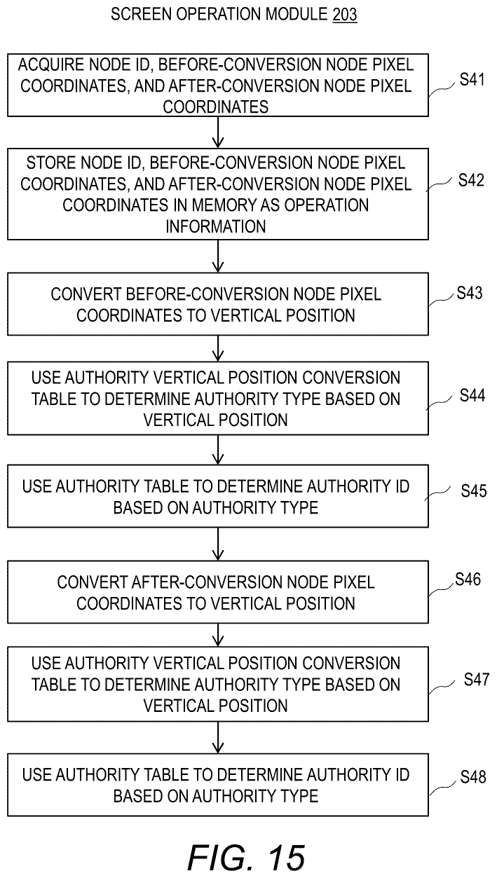

FIG. 15 is a flowchart for illustrating a processing example by the screen operation module 203. The screen operation module 203 executes processing in response to an operation in the individual workflow 10 by the user. The screen operation module 203 acquires the node ID, before-conversion node pixel coordinates, and after-conversion node pixel coordinates in response to the movement of a node by the user (S41). Further, the screen operation module 203 stores the acquired node ID, before-conversion node pixel coordinates, and after-conversion node pixel coordinates in the memory 252 as operation information 232 (S42).

Next, the screen operation module 203 converts the before-conversion node pixel coordinates to a vertical position (S43). Further, the screen operation module 203 uses the authority vertical position conversion table 217 to determine the authority type based on the vertical position (S44). Next, the screen operation module 203 uses the authority table 213 to determine the authority ID based on the authority type (S45).

Next, the screen operation module 203 converts the after-conversion node pixel coordinates to a vertical position (S46). Further, the screen operation module 203 uses the authority vertical position conversion table 217 to determine the authority type based on the vertical position (S47). The screen operation module 203 uses the authority table 213 to determine the authority ID based on the authority type (S48).

The operation content processing module 204 determines the content of the change in the information on the individual workflow 10 based on the operation content indicated by the operation information 232, which is the result of processing by the screen operation module 203. In addition, the operation content processing module 204 calls the authority information reflection module 205, and the authority information reflection module 205 updates the relationship management table 215 in accordance with the content of the change.

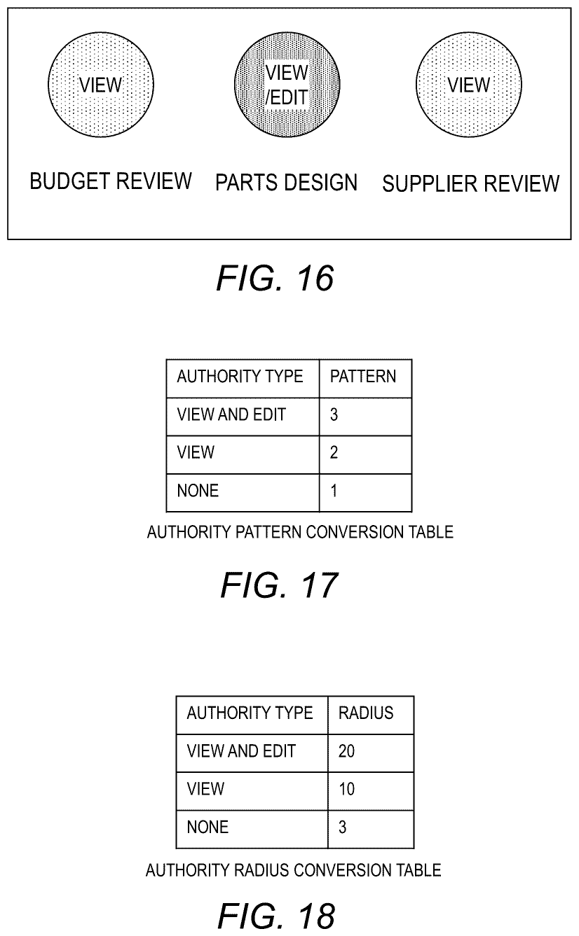

Next, description is given of another example of the GUI image for displaying and setting the authorities for each task of a role in a workflow. The above-mentioned example uses the vertical axis positions of the nodes as a display method in accordance with the authority type. In the following description, as another example of a display method that changes in accordance with the authority type, the appearance of the node is changed. In FIG. 16, an example of node images displayed on the individual workflow screen is illustrated. Unlike the example described with reference to FIG. 1 and FIG. 2, the nodes for respective tasks are displayed in a horizontal line.

In FIG. 16, as an example, nodes representing authorities for budget review, parts design, and supplier review are illustrated. The image of each node shows the authority granted to the node based on a paint pattern of the image. In the example illustrated in FIG. 16, the pattern for the view authority is a thinner dot pattern than the pattern for the view/edit authority. For example, a node having no authorities may have no pattern, or specifically, the node may be white. In addition to expressing authorities based on the node position as illustrated in FIG. 1 and FIG. 2, authorities can be expressed in this manner based on the pattern or color of the nodes. In addition, authorities may be expressed based on the external shape or size of the nodes.

In FIG. 17, a configuration example of an authority pattern conversion table is shown. The authority setting support device 2 can store the authority pattern conversion table in place of the authority vertical position conversion table 217. Further, nodes having a pattern corresponding to the authority can be displayed by using information on the pattern of the nodes in place of information on the vertical position of the nodes. The authority setting support device 2 receives, for example, a node selection based on the positioning of a pointer by the user and an authority change (pattern change) based on a mouse click.

In FIG. 18, a configuration example of an authority radius conversion table is shown. The authority setting support device 2 can store the authority radius conversion table in place of the authority vertical position conversion table 217. Further, nodes having a radius corresponding to the authority can be displayed by using information on the radius of the nodes in place of information on the vertical position of the nodes. The authority setting support device 2 receives, for example, a node selection based on the positioning of a pointer by the user and an authority change (radius change) based on a mouse click or pressing of an enter key.

### Second Embodiment

In a second embodiment of this specification, the overall workflow is displayed in addition to an individual workflow. The overall workflow displays the authorities for each task in each role in the workflow. As a result, the user can easily check the authority type for each task in each role.

For example, the authority setting support device 2 displays the overall workflow before displaying an individual workflow. The authority setting support device 2 may receive a designation of a role by the user in the overall workflow, and display the individual workflow of the designated role. The various methods of displaying the nodes of an individual workflow described in the first embodiment can be applied to the overall workflow.

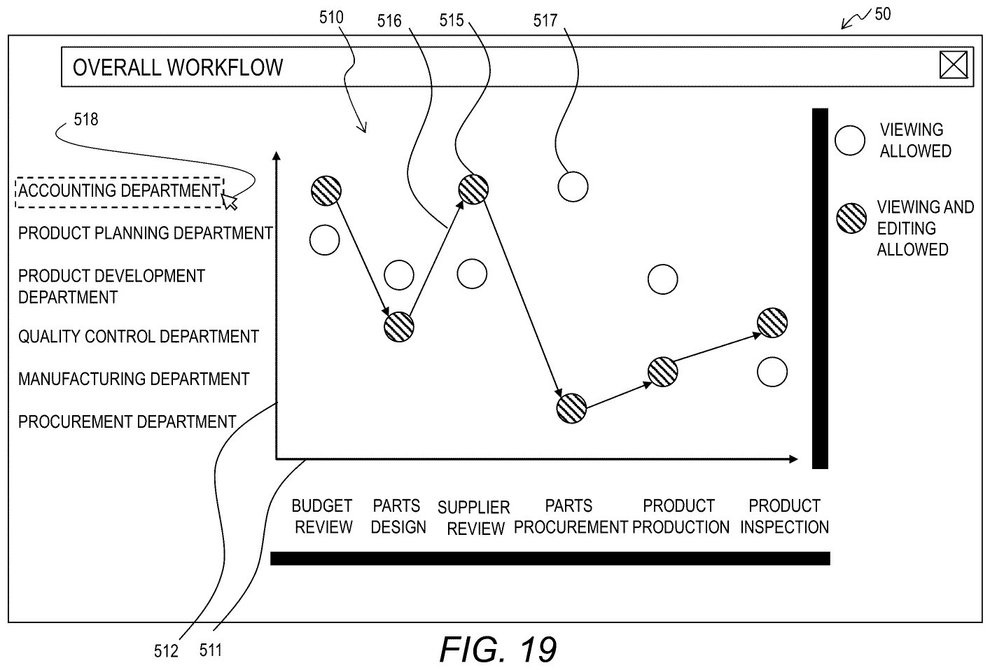

In FIG. 19, an example of an overall workflow 50 in the second embodiment of this specification is illustrated. The overall workflow 50 displays a graph 510 for showing the authorities granted to respective roles in each task. The graph 510 has a horizontal axis 511 indicating tasks (actions) to be sequentially performed in a workflow, and a vertical axis 512 indicating roles. In other words, different positions (coordinates) on the vertical axis indicate different roles, and different positions (coordinates) on the horizontal axis indicate different tasks. In the example illustrated in FIG. 19, the graph 510 is defined by two axes that are perpendicular to each other, but in another embodiment, the angle between the axes may not be perpendicular, or more than two axes may be defined.

As described in relation to the individual workflow 10, an access authority for task-related data is granted to each task, and an authority type which allows viewing and editing, an authority type which allows only viewing, and an authority type which prohibits both editing and viewing are defined. The graph 510 represents the authority for each task in each role by using nodes. The position (coordinates) of a node indicates the role and the task, and the appearance of the node indicates the authority type.

The graph 510 displays the authority type which allows viewing and editing and the authority type which allows only viewing by using nodes 515 and 517 which have different appearances from each other. Nodes of the type having no authorities are not displayed. In the example illustrated in FIG. 19, the external shape of the displayed nodes is circular, and the paint pattern differs between different authority types. The nodes 515 represent the authority type which allows viewing and editing, and the nodes 517 represent the authority type which allows only viewing. The nodes 517 are white circles which do not have a pattern. As an example, one node of each of those types of authorities is indicated by reference numeral 515 or 517. In place of a pattern, a color, a shape, or a size may be different between different authority types.

In the graph 510, adjacent nodes indicating the authority type which allows viewing and editing are connected by an edge 516. Each edge 516 is represented by an arrow. In FIG. 19, one edge is denoted by reference numeral 516 as an example. The edges 516 can indicate the execution order of the tasks in the workflow and the role of the main person in charge of the task (role having the authority type which allows viewing and editing). Each edge connects between nodes of an authority type designated in advance for adjacent tasks in the flow. The designated authority type is determined in accordance with the overall workflow.

The authority setting support device 2 receives selection of a role by the user in the overall workflow 50, and displays the individual workflow 10 of the selected role. For example, the user can move a pointer 518 to the position of any role on the vertical axis, and select that role by clicking the mouse or pressing the enter key.

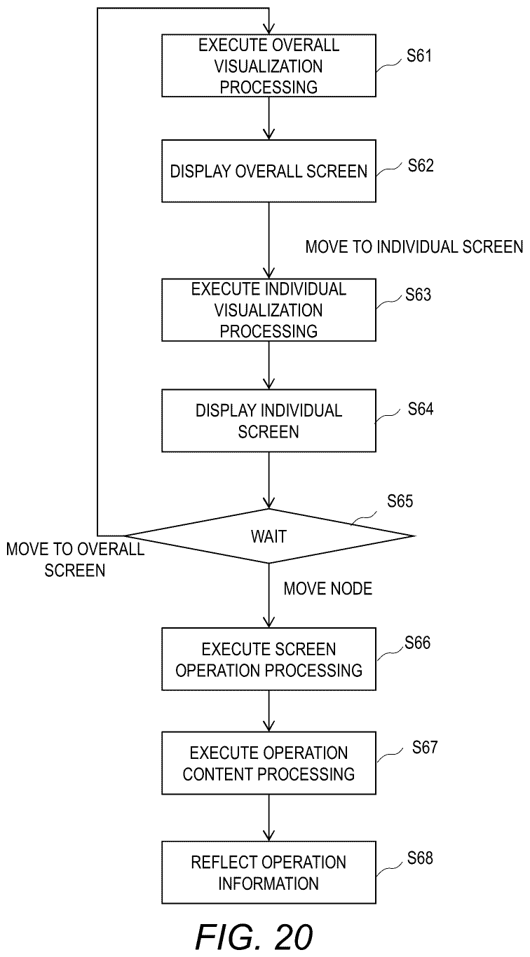

FIG. 20 is a flowchart for illustrating an example of overall processing by the authority setting support device 2, including display of the overall workflow 50 and the individual workflow 10. The authority setting support device 2 executes overall visualization processing to obtain information for displaying the overall workflow 50 (S61), and executes overall screen display processing based on the result of the overall visualization processing (S62). The overall screen display processing draws the overall workflow 50.

When any role is selected in the overall workflow 50, the authority setting support device 2 executes individual visualization processing (S63). This processing is performed by the individual visualization processing module 201 described with reference to FIG. 13. Next, the authority setting support device 2 executes an individual screen display (S64). This processing is performed by the individual screen display module 202 described with reference to FIG. 14.

When an operation to close the individual workflow 10 is performed, or when a “back” button (not shown) is pressed to instruct a return to the overall screen, or when no operation is performed for a predetermined period of time (S65: “move to overall screen”), the flow returns to Step S61.

When a node movement operation by the user is executed in the individual workflow 10 (S65: “move node”), the authority setting support device 2 executes screen operation processing (S66). This processing is performed by the screen operation module 203 described with reference to FIG. 15.

Next, the authority setting support device 2 executes operation content processing (S67), and further executes operation information reflection processing (S68). Specifically, the operation content processing module 204 determines the content of the change in the information on the individual workflow 10 based on the operation content indicated by the operation information 232, which is the result of processing by the screen operation module 203. Further, the operation content processing module 204 calls the authority information reflection module 205, and the authority information reflection module 205 updates the relationship management table 215 in accordance with the content of the change.

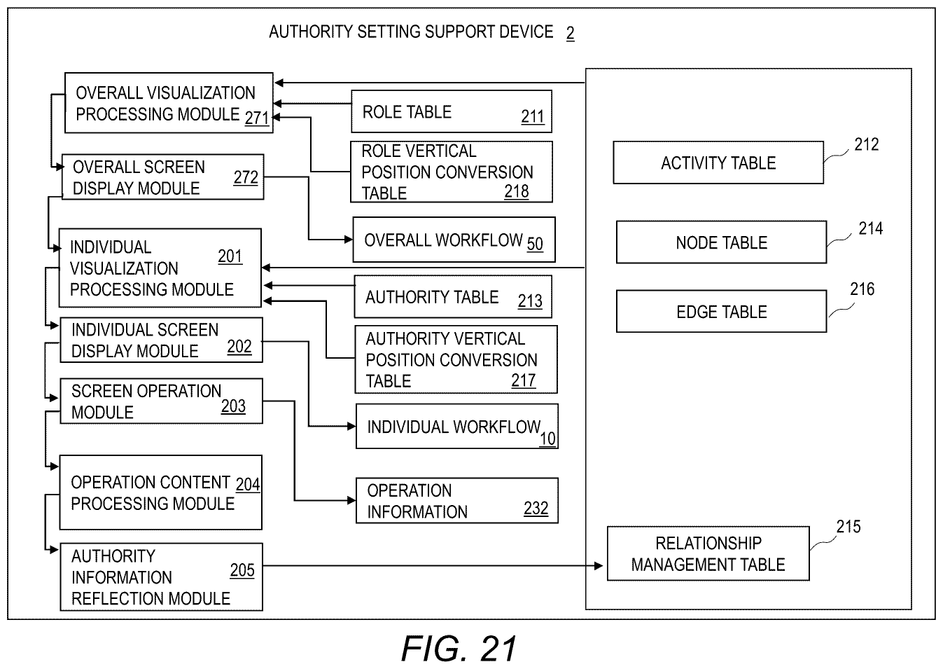

FIG. 21 is a diagram for illustrating a logical configuration and a processing outline of the authority setting support device 2 which displays the overall workflow 50 and the individual workflow 10. Differences from FIG. 12 are mainly described. The authority setting support device 2 includes an overall visualization processing module 271 and an overall screen display module 272. Those modules can be implemented by the CPU 251 executing a corresponding program stored in the memory 252. The authority setting support device 2 further includes a role vertical position conversion table 218.

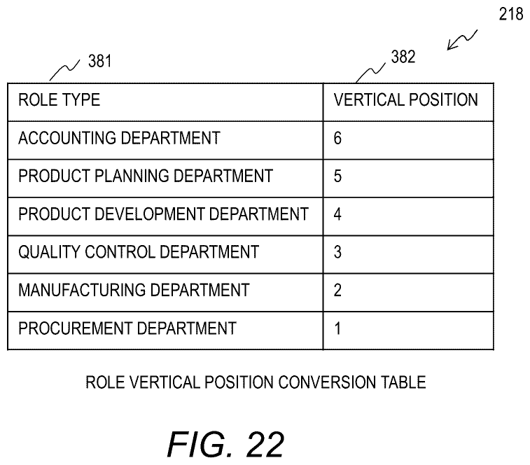

In FIG. 22, a configuration example of the role vertical position conversion table 218 is shown. The role vertical position conversion table 218 manages the position of each role on the vertical axis (Y axis) of the graph 510 in the overall workflow 50. Specifically, the role vertical position conversion table 218 has a role type column 381 and a vertical position column 382. The role type column 381 indicates the type (name) of the role in the workflow, and the vertical position column 382 indicates the position of each role type on the vertical axis of the graph 510 in the overall workflow 50. The role vertical position conversion table 218 is stored in, for example, the auxiliary storage device 253.

Returning to FIG. 21, an outline of the display and the operation of the overall workflow 50 is described. The overall visualization processing module 271 acquires visualization information, which is information for displaying the overall workflow 50, from the role table 211, the role vertical position conversion table 218, the node table 214, the edge table 216, and the relationship management table 215. The overall visualization processing module 271 calls the overall screen display module 272. The overall screen display module 272 generates and displays an image of the overall workflow 50 based on the obtained visualization information. When a role is designated by the user in the overall workflow 50, the overall screen display module 272 calls the individual visualization processing module 201. The individual visualization processing module 201 starts processing for displaying the above-mentioned individual workflow 10.

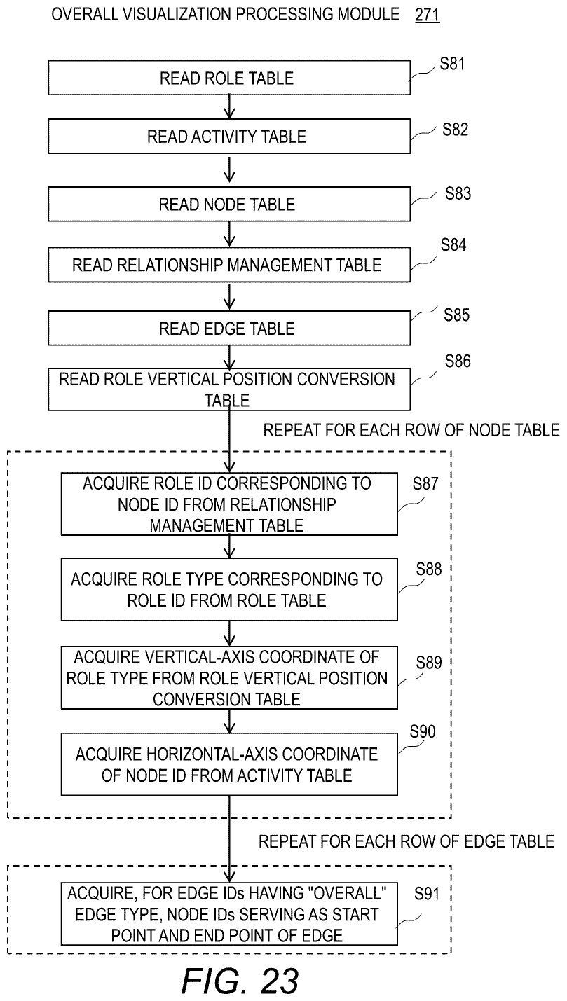

A processing example by each function module for the overall workflow 50 is now described. FIG. 23 is a flowchart for illustrating an example of processing executed by the overall visualization processing module 271. The overall visualization processing module 271 reads the information to be used in the processing. Specifically, the overall visualization processing module 271 reads the role table 211, the activity table 212, the node table 214, the relationship management table 215, the edge table 216, and the role vertical position conversion table 218 (S81 to S86).

Next, the overall visualization processing module 271 executes Step S87 to Step S90 for each node ID indicated by the node table 214. Specifically, the overall visualization processing module 271 acquires the role ID corresponding to the node ID from the relationship management table 215 (S87). Next, the overall visualization processing module 271 acquires the role type corresponding to the acquired role ID from the role table 211 (S88). Next, the overall visualization processing module 271 acquires the vertical-axis coordinate (vertical position) of the acquired role type from the role vertical position conversion table 218 (S89). Further, the overall visualization processing module 271 acquires the horizontal-axis coordinate (X coordinate) of the node ID from the activity table 212 (S90).

Next, the overall visualization processing module 271 executes Step S91 for each edge ID indicated by the edge table 216. Specifically, the overall visualization processing module 271 acquires, for the edge IDs having an “overall” edge type, node IDs serving as the start point and end point of the edge (S91).

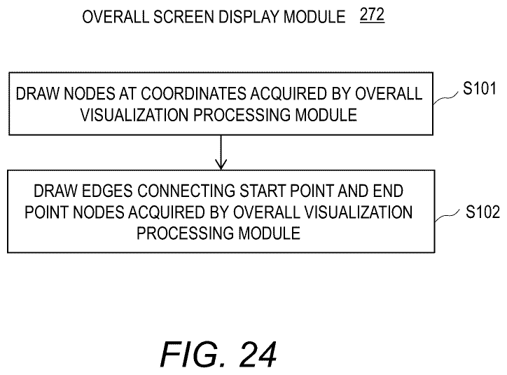

FIG. 24 is a flowchart for illustrating a processing example by the overall screen display module 272. The overall screen display module 272 draws the overall workflow 50. The overall screen display module 272 draws the nodes in the graph 510 of the overall workflow 50 at the coordinates acquired by the overall visualization processing module 271 (S101). Further, the overall screen display module 272 draws, in the graph 510 of the overall workflow 50, the edges connecting the start point and end point nodes acquired by the overall visualization processing module 271 (S102). The role table 211 and the activity table 212 may be referred to in order to display non-variable information such as the roles on the vertical axis and the tasks on the horizontal axis in the overall workflow 50.

### Third Embodiment

In a third embodiment of this specification, an administrator (approver) can approve or reject role authority changes. In the third embodiment, the execution timing of each of the operation content processing (S67) and the operation information reflection processing (S68) is different from that in the second embodiment. Specifically, processing is stopped after the operation content processing (S67) is executed. Further, the authority setting support device 2 waits for an approval request from the user terminal 3 of the person setting the authorities (for example, a system engineer).

After receiving the approval request, the authority setting support device 2 activates an “approve” button 161 and a “reject” button 162 on the user terminal 4 of the administrator. When the “approve” button 161 or the “reject” button 162 is pressed, the authority setting support device 2 receives an approval response or a rejection response from the user terminal 4 of the administrator, and executes operation information reflection processing (S68). Further, the “approve” button 161 and the “reject” button 162 are deactivated.

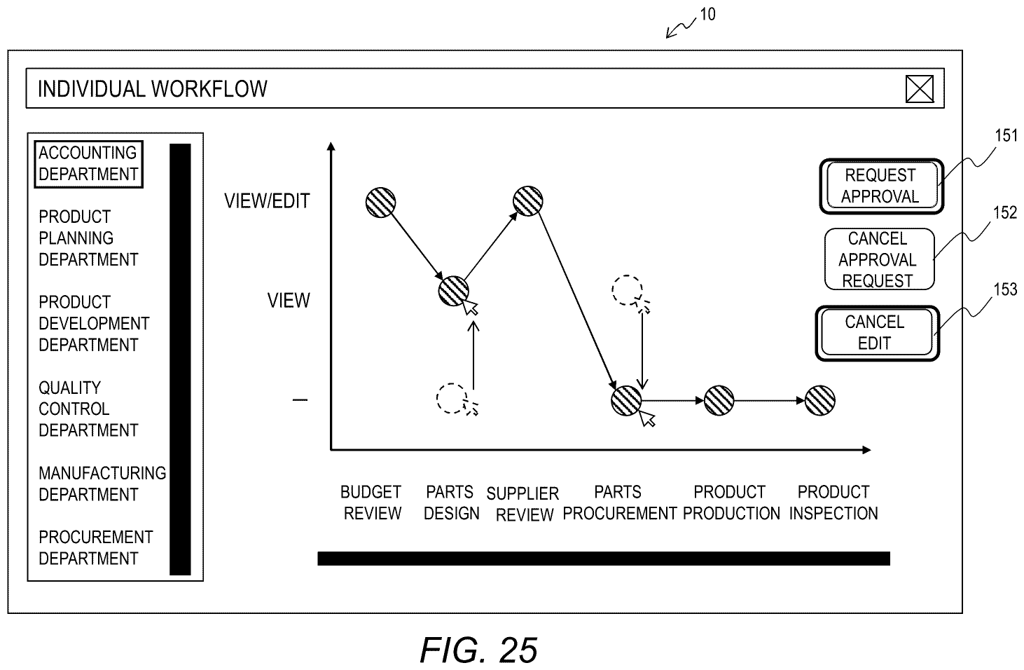

In FIG. 25, an image example of the individual workflow 10 displayed on the user terminal 3 of the person setting the authorities (editor) is shown. Three buttons 151, 152, and 153 are added to the image example illustrated in FIG. 2. Those three buttons are a “request approval” button 151, a “cancel approval request” button 152, and a “cancel edit” button 153.

The individual screen display module 202 activates the “request approval” button 151 and the “cancel edit” button 153 only when there is an edit to the graph 110 as described with reference to FIG. 2 and before the “request approval” button 151 has been pressed. The “cancel approval request” button 152 is activated only during the period until an approval or a rejection is performed after a request for approval has been sent to the administrator. The screen operation module 203 maintains an edited state (operation information 232) after the “cancel approval request” button 152 is pressed. When the “cancel approval request” button 152 is selected after a request for approval is made, the approval processing is halted.

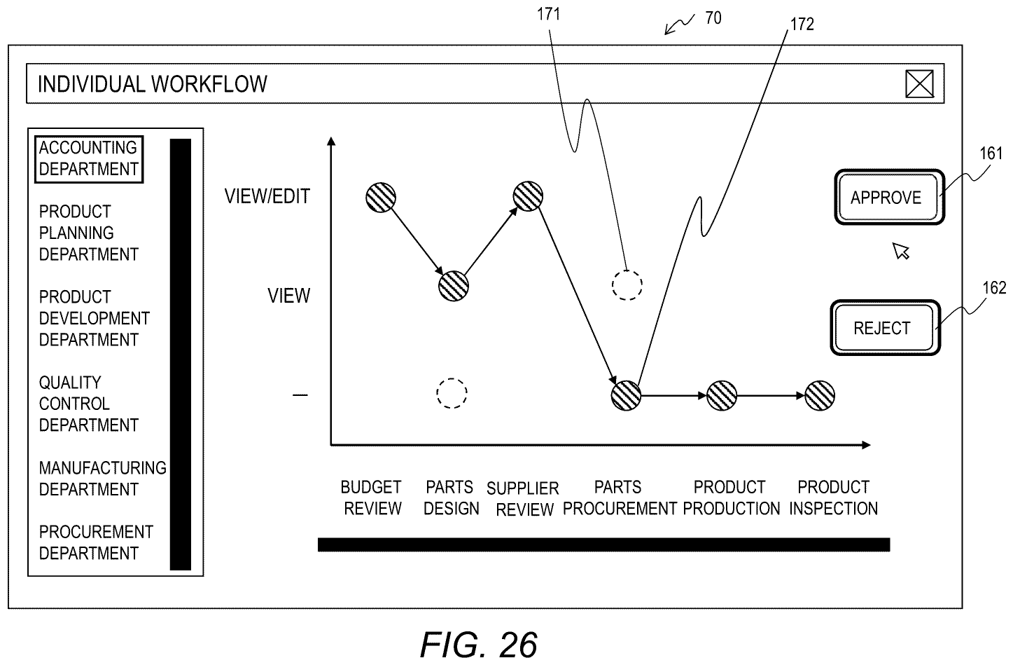

When the “request approval” button 151 is pressed, the individual screen display module 202 draws an individual workflow of the request for approval on the user terminal 4 of the administrator based on the content of the change in the set authority included in the operation information 232. In FIG. 26, an example of an individual workflow 70 which is a GUI image displayed on the user terminal 4 of the administrator is illustrated.

One of the differences between the individual workflow 70 and the individual workflow 10 is that the individual workflow 70 displays a node 171 indicating the authority before a change in addition to a node 172 indicating the authority after the change. In the example of FIG. 26, one after-change node is denoted by reference numeral 172 as an example, and a corresponding one before-change node is denoted by reference numeral 171 as an example. The administrator can easily recognize the content of the change in the authority in the individual workflow 70.

Further, the individual workflow 70 for approval includes the activated “approve” button 161 and “reject” button 162 in place of the buttons 151 to 153 of the individual workflow 10 for editing. When the “approve” button 161 is selected by the administrator in the individual workflow 70 for approval, the individual screen display module 202 deletes the before-change node, and deactivates the “approve” button 161 and the “reject” button 162.

The screen operation module 203 adds information indicating that the change in the authority is approved to the operation information 232, which is temporary information, and calls the operation content processing module 204. As a result, the result of the approved authority change is reflected in the relationship management table 215. Further, the fact that approval has been obtained by the administrator may be displayed in the individual workflow 10 of the editor.

When the “reject” button 162 is selected by the administrator in the individual workflow 70 for approval, the individual screen display module 202 returns the individual workflow 10 of the editor to the state before editing. In addition, the individual screen display module 202 may display in the individual workflow 10 of the editor the fact that the administrator has rejected the change in the authority.

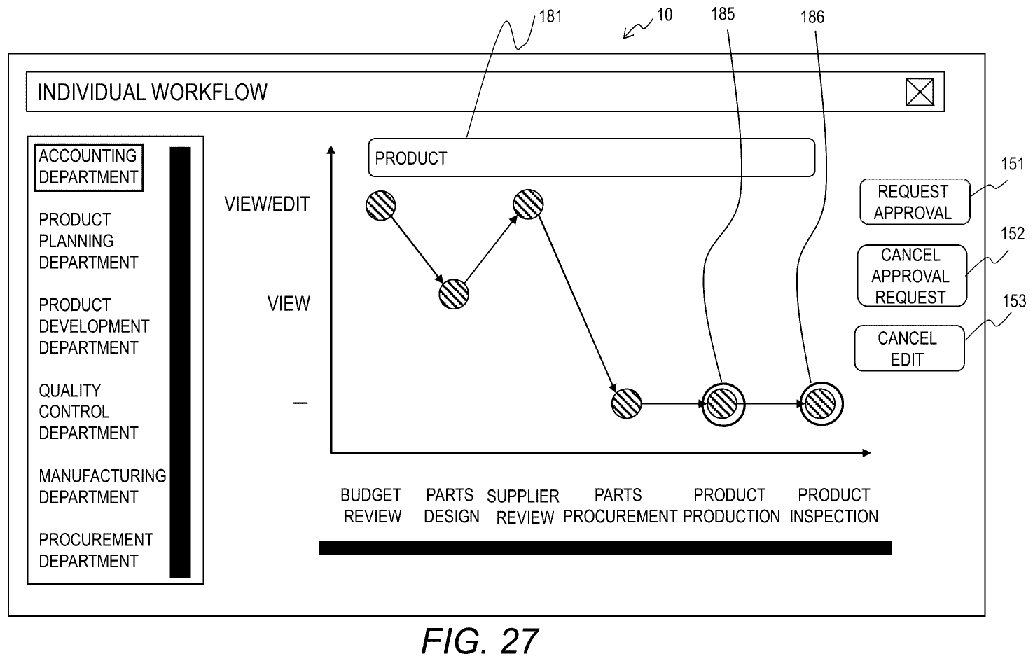

Next, description is given of examples of other components that can be included in the individual workflow 10. In FIG. 27, an example of an individual workflow 10 which includes a search window 181 is shown. A search window can also be included in the overall workflow 50.

When a keyword is input into the search window 181, the individual screen display module 202 identifies tasks that match the keyword in the activity table 212, and highlights and displays the nodes corresponding to those tasks. In this example, nodes of tasks containing the keyword “product” are highlighted and displayed. In the example shown in FIG. 27, two of such nodes, namely, a node 185 and a node 186, are highlighted by displaying a second circle. The highlighting method is not limited to this, and a change in a color or a shape may also be used.

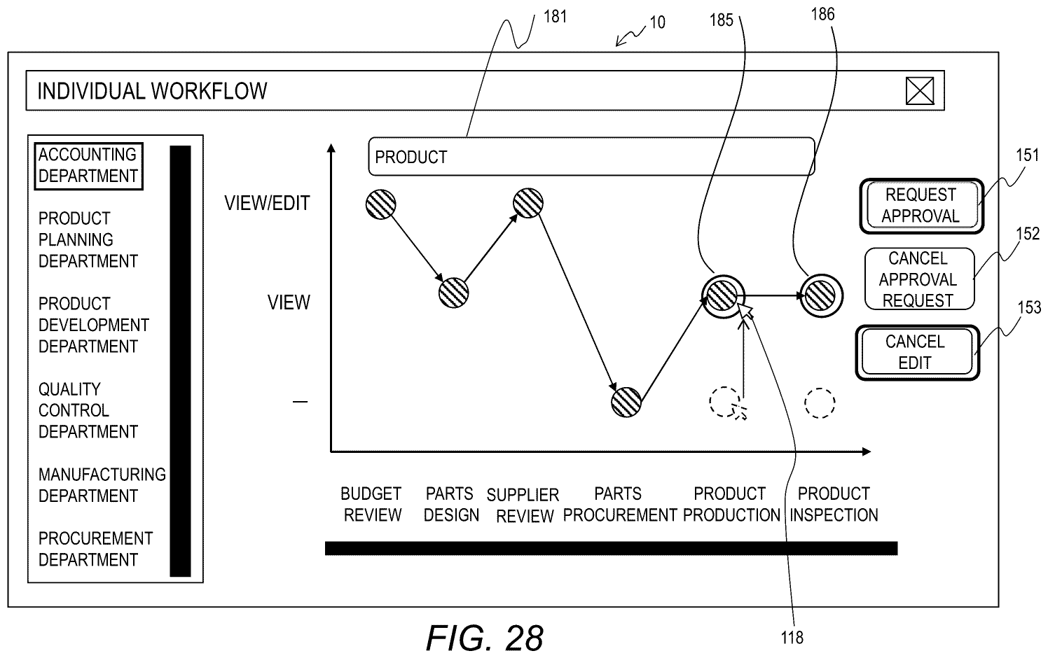

The individual screen display module 202 receives movement of the highlighted nodes 185 and 186 performed with use of the pointer 118, for example. When one of the highlighted nodes 185 and 186 is selected and moved by the pointer, the individual screen display module 202 also moves the other of the nodes 185 and 186 to a common vertical position (authority type). In FIG. 28, the node 186 is shown as having also been simultaneously moved to the authority type “view” in response to the node 185 being moved by the pointer from the authority type “-” to the authority type “view”. The search function allows users to easily find desired tasks from among many tasks and to move those tasks efficiently. The nodes retrieved in the search may be moved individually.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A system for supporting setting of authorities to be granted to roles in a workflow, the system comprising:
a storage device; and
a processor,
wherein the storage device stores:
task information for managing a position corresponding to each of tasks in the workflow;
relationship management information for managing a relationship among nodes, authority types, and the tasks; and
conversion information for managing a relationship between the authority types and a display method for each of the nodes, and
wherein the processor is, in a display of a first workflow, configured to:
determine a position of the each of the nodes by referring to the relationship management information and the task information;
determine a display method for the each of the nodes by referring to the relationship management information and the conversion information;
display the each of the nodes at the determined position corresponding to one of the tasks based on the determined display method representing the authority type; and
change a display method for a first node in response to a user operation of changing the authority type of the first node.

2. The system according to claim 1,
wherein the task information manages the position corresponding to the each of the tasks on a first axis which is linear, and
wherein the display method for the each of the nodes indicates a position on a second axis which intersects the first axis and which is linear.

3. The system according to claim 2, wherein the processor is configured to:
change a display position of the first node on the second axis in response to an operation of moving the first node along the second axis by a user, and
update the relationship management information based on an authority type corresponding to the changed display position of the first node.

4. The system according to claim 2, wherein the first axis and the second axis are perpendicular.

5. The system according to claim 1, wherein the processor is configured to display an edge which connects nodes that are adjacent in an execution order of the tasks in the first workflow.

6. The system according to claim 1,
wherein the first workflow shows authority types of an individual workflow of one role selected from a plurality of roles,
wherein the relationship management information manages a relationship among the selected one role, the nodes, the authority types, and the tasks,
wherein the storage device stores role information for managing a position corresponding to each of the plurality of roles, and
wherein the processor is configured to:
display an overall workflow including nodes indicating authority types for tasks in each of the plurality of roles;
determine positions of the nodes in the overall workflow by referring to the role information, the task information, and the relationship management information; and
display, in the overall workflow, nodes having different authority types by using different appearances.

7. The system according to claim 6, wherein the processor is configured to indicate, in the overall workflow, one authority type designated in advance, and to display an edge which connects nodes that are adjacent in an execution order of the tasks.

8. The system according to claim 1, wherein the processor is configured to:
transmit a request for approval of a change in the authority type of the first node to an approver terminal; and
update, when an approval response from the approver terminal is received, the relationship management information in accordance with the change in the authority type of the first node.

9. The system according to claim 1, wherein the processor is configured to highlight and display a node of a task which matches a search word that has been input.

10. The system according to claim 9, wherein the processor is configured to change, in response to a user operation of changing the authority type of one node among nodes of a plurality of tasks which match the search word, the authority types of all of the nodes of the plurality of tasks to the same authority type.

11. A method of supporting, by a system, setting of authorities to be granted to roles in a workflow,
the system being configured to store:
task information for managing a position corresponding to each of tasks in the workflow;
relationship management information for managing a relationship among nodes, authority types, and the tasks; and
conversion information for managing a relationship between the authority types and a display method for each of the nodes,
the method, which is executed by the system, comprising, in a display of a first workflow:
determining a position of the each of the nodes by referring to the relationship management information and the task information;
determining a display method for the each of the nodes by referring to the relationship management information and the conversion information;
displaying the each of the nodes at the determined position corresponding to one of the tasks based on the determined display method representing the authority type; and
changing a display method for a first node in response to a user operation of changing the authority type of the first node.
